(19) United States
(12) Patent Application Publication
(10) Pub. No.: US 2008/0220715 A1
(43) Pub. Date: Sep. 11, 2008

(54) Controlling Use Of Devices In Large Restricted Areas

(76) Inventors: Bhartendu Sinha, Bangalore (IN); Joseph Meehan, Valbonne (FR); Jithendranadh Niruthambath, Bangalore (IN)

Correspondence Address: TEXAS INSTRUMENTS INCORPORATED, P O BOX 655474, M/S 3999, DALLAS, TX, 75265, US

(21) Appl. No.: 11/684,354

(22) Filed: Mar. 9, 2007

(51) Int. Cl. H04K 3/00

(52) U.S. Cl. 455/1

(57) ABSTRACT

A usage specification device is used to limit the use of information signals (audio, image, data) and to limit the output of disturbing signals (speaker, flash, light, RF transmission) in several devices in a large restricted area. For example, the usage specification device may transmit a certain type of control signal to disable image capture by camera-equipped portable/mobile devices, or it may transmit other types of control signals to disable audio capture or data capture by such devices. Similarly, the specification device may transmit a certain type of control signal to reduce the speaker volume on portable/mobile devices, or it may transmit other types of control signals to disable the flash, or minimize the intensity of light emitted by the display or restrict the transmission of RF signals from such devices. Due to such features, only undesirable features of portable/mobile devices may be prevented in restricted areas, while permitting other uses. According to another aspect, the device can be scanned by an external scanner for a built-in code, with the code indicating the specific type of capabilities the device has and the specific type of usage controls supported by the device. Accordingly, the owner of a premises may first scan a device to determine the specific capabilities and control features supported before permitting the device to be carried into the premises.

### BACKGROUND OF THE INVENTION

1. Field of the Invention

The present invention relates generally to electronic devices such as mobile phones and cameras, and more specifically to a method and apparatus for controlling the use of such devices in large restricted areas.

2. Related Art

There is often a need to control use of devices in large restricted areas. For example, there are devices such as mobile phones and cameras which could be carried around in large theaters or security premises. It may be desirable to prevent information capture such as audio/data/image capture or signal outputs such as speaker/flash (generally associated with photography)/light (generally associated with display)/RF transmission (generally restricted in aircraft, near medical instrumentations, etc.) outputs in such areas.

Accordingly, there is a generally recognized need felt to restrict/control the usage of such devices. For example, instructions are placed in several places to switch off mobile phones. One problem with switching off the device is that there may be permissible purposes (e.g., playing games on the phone, or making emergency phone calls), which are also disabled by switching off the mobile phones. Moreover the users of the devices may not comply with such restrictions.

Accordingly, in some scenarios (e.g., in movie theaters), interfering wireless (jamming) signals are transmitted which cause information signals carrying voice conversations to be un-decodable. That is, the signals received by the mobile phone may not be able to decode the information signals due to the interference of the jamming signals.

One problem with the jamming approach is that several uses, which would normally be acceptable, are also disabled by the jamming signals. For example, a mobile phone user may wish to receive phone calls in ‘silent mode’, but even such calls are not received due to the jamming signals. Similarly, message delivery and emergency calls may also be disabled, which may be undesirable.

Moreover, some of the undesirable features may not be disabled by the jamming approach. For example, a mobile phone may be equipped with image capture ability, and it may be desirable to prevent photography in that area. The jamming approach would not prevent such undesired photography. Similarly, jamming signals cannot limit the audio and data capture capabilities of electronic devices in general. In addition, unacceptable disturbances from electronic devices such as sounds from the speaker or light from the flash/display or potentially interfering RF transmissions cannot be controlled by the jamming approach.

What is therefore needed is a flexible approach which enables the usage of such devices to be controlled.

### BRIEF DESCRIPTION OF THE DRAWINGS

The present invention will be described with reference to the following accompanying drawings.

FIG. 1 is a block diagram of an example environment in which various aspects of the present invention are implemented.

FIG. 2 is a flow chart illustrating the manner in which an usage control block operates to control use of devices according to various aspects of the present invention.

FIG. 3 is a flow chart illustrating the manner in which the use of many devices can be controlled from a single usage specification device according various aspects of the present invention.

FIG. 4 is a block diagram illustrating how the usage of devices in a zone can be controlled in an embodiment of the present invention.

FIG. 5A is a block diagram illustrating the manner in which usage of information signals can be controlled in a direction according to various aspects of the present invention.

FIG. 5B is a block diagram illustrating the manner in which capture of images is restricted in a direction in an embodiment.

FIG. 6 is a block diagram illustrating the use of a scanning device to determine whether a portable device is compliant to provide various features of the present invention in an embodiment.

FIG. 7 is a block diagram illustrating the details of a device operating according to various aspects of the present invention.

FIG. 8 is a block diagram illustrating the details of a system in which various features of the present invention are operative upon execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention provides a usage specification device which transmits control signals over a long distance (e.g., substantially more than 15 feet), with the control signals being designed to indicate the manner in which the use of an information signal (e.g., light/sound/data signals representing information captured by the device from the external environment) is to be limited. Devices receiving the control signals limit the use of the information signal according to the received control signal. Accordingly, the manner in which information signals are used by devices can be controlled in an area of interest.

The control signals from a usage specification device can limit usage of different information signals in different ways. For example, a usage specification device may transmit one type of control signal to disable/prevent audio or data capture by using a portable device, and another type of control signal to prevent image capture in various devices in the area. Due to such an approach, only desired uses of information signals can be prevented or permitted in a large area, as desired.

In one embodiment, the control signals cause a receiving device to disable all voice/mobile conversations other than emergency calls. Such a feature is particularly useful in mobile phones since only the undesirable voice conversations can be disabled, while other features (including calls to emergency services) are potentially not affected. The voice conversations are encoded in radio frequency (RF) signals.

According to an aspect of the present invention, a usage specification device is provided to transmit control signals having sufficient strength to cover a desired zone (area). For example, the control signal may indicate that no video capture is to be performed in the zone. A usage control block provided within all devices compliant with various features of the present invention, may then disable video capture/recording (in the corresponding device) upon receiving the control signal (even if information signal representing video images are readily received in a decodable form for recording).

Another aspect of the present invention uses the zonal control of above to control the speaker, flash, light or RF transmission generating audio/visual/RF disturbances in a zone. As an illustration, a usage specification device transmits control signals, which indicates that the speaker (audio) level is to be reduced in the corresponding zone/area. Upon receiving the control signal, the usage control block may either reduce the speaker level or entirely mute the speaker.

Another aspect of the present invention uses another type of control signals to prevent image capture of objects/area of interest. In an embodiment, a usage specification device is provided on the specific object for which image capture is sought to be prevented, with the usage specification device transmitting signals with the reverse direction of the signals indicating the specific direction in which image capture is prohibited. A unidirectional antenna is provided in the usage control block of the device with the antenna configured to receive signals from the same direction from which the device's lens will capture images. Thus if the image capturing system in the device faces the object of interest within a certain range, the device's directional antenna will detect the signal (exceeding a pre-specified power level) transmitted by the object of interest, and the usage control block within the device will disable image capture in that direction

Yet another aspect of the present invention provides mechanism by which one can detect whether various usage control features noted above are supported in a device. The device may be designed to include a code indicating the specific usage control features supported. The code may be caused to be transmitted when the device is subjected to a scan operation by a scanner. Thus, the absence of reception of such a code may be used to indicate that the features are entirely not supported. On the other hand, when the code is received in response to the scan operation, the code is examined to determine the specific features that are supported. Based on support for the specific features, the operation (or even presence) of the device may be prevented or permitted in the specific areas.

One more aspect of the present invention provides different types of control signals for controlling different types of usages. In an embodiment, different frequencies of carrier signals are used for controlling different types of uses. For example, one frequency may be used to control video capture (as noted in previous paragraph), while other frequencies may be used to control audio/data capture or output of speaker/flash/light/RF transmission signals by the device. Thus, when a device receives a control signal with such other frequencies, audio capture may be disabled on the device.

One more aspect of the present invention provides an architecture which enables a device to support some or all the features noted above.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Example Environment

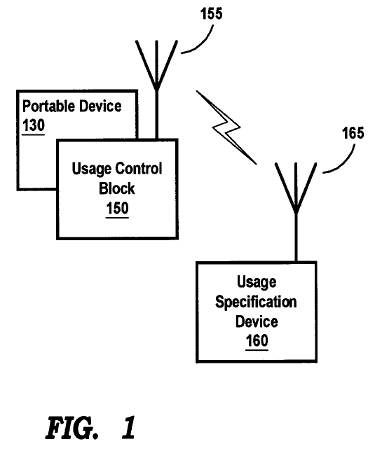

FIG. 1 is a block diagram illustrating the details of an example environment in which various aspects of the present invention can be implemented. The environment is shown containing portable device 130 and usage specification device 160. For illustration, only one portable device is shown. However, many such devices may be present within a large area, and usage specification device 160 controls the use of several of such devices as described below in further detail.

Portable device 130 represents a device having the ability to communicate on wireless medium using antenna 155, and can be used in various ways depending on the content of information signals. For example, when used as a mobile phone, the information signal encodes voice communications (cellular RF transmissions). When used as an image capture device (e.g., digital camera), the information signal encodes images. When used as an audio recorder (or player), the information signal encodes audio information. Portable device 130 may include the ability to use one or more of such information signals. While antenna 155 is shown being used to transmit/receive both information signals and control signals, it should be appreciated that multiple antennas can be provided, each designed for specific/corresponding purpose.

Portable device 130 is embedded with a usage control block 150 that has the ability to communicate on wireless medium via antenna 155 and via antenna 165 to a usage specification device 160 in the vicinity of the device. The device's usage modes can also be limited in various ways depending on the control communication between the device's usage control block and the usage specification device. In effect, usage control block 150 operates in conjunction with usage specification device 160 (using wireless control signals transmitted using antenna 165) to enable the use of portable device 130 to be flexibly controlled, as described below in further detail.

3. Controlling Use of Portable Device

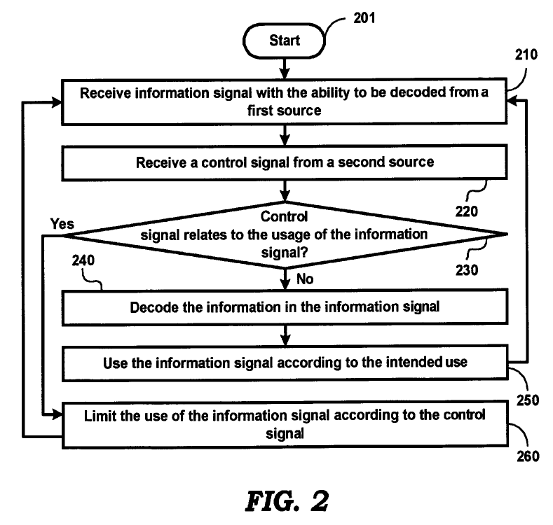

FIG. 2 is a flowchart illustrating the manner in which portable device 130 may operate to provide various features of the present invention. The flowchart is described with reference to FIG. 1 for illustration. However, the approaches can be used in other environments without departing from the scope and spirit of various aspects of the present invention, as will be apparent to one skilled in the relevant arts by reading the disclosure provided herein. The flowchart begins in step 201, in which control is transferred to step 210.

In step 210, portable device 130 receives from a first source an information signal with the ability to be decoded. In general, decoding refers to extracting the information content from the received signal. For example, portable device 130 receives a voice encoded wireless signal from a transmitter of a mobile phone network or an image from a place/ person of interest. The first source can be internal to the portable device (e.g., a secondary storage storing songs).

Since the information signal is received in a form with the ability to be decoded, portable device 130 can generate a sequence of digital codes (or other internal suitable form) representing the voice/image content, and potentially use the information consistent with the intended usage (play voice, record/play images, etc.). Various aspects of the present invention enable the use of the information signals to be controlled, as described below.

In step 220, portable device 130 (or specifically usage control block 150 using antenna 155) receives a control signal from a second source. The control signal is encoded in a carrier signal which can be received with more than a pre-specified strength (e.g. −100 dBm or −110 dBm) in an area within a desired (long) distance. In an embodiment, the carrier signal corresponds to RF signals.

Thus, with respect to FIG. 1, the control signal is received from usage specification device 160. The control signals may be received using any signal encoding and conventions with consistent implementation in both usage specification device 160 and usage control block 150. However, since the devices in large areas are to be covered, signals such as RF signals, which are suited for transmission over long distance, can be used.

In one embodiment, the simple presence (reception) of different frequencies of control signals are used as the basis to prohibit the device's ability to capture different types of information signals (e.g. audio, data, image) or to prohibit the device's ability to output different types of signals (e.g. speaker, flash, light, RF transmission). Alternatively, extensive formats of control signals can be used to more flexibly control individual capabilities of devices.

Continuing description of FIG. 2, in step 230, usage control block 150 determines whether the control signal relates to the usage of the information signal received in step 210. If the control signal relates to the usage of information signal, control passes to step 260, otherwise to step 240.

In step 240, portable device 130 decodes the information signal and in step 250 uses the information signal according to the intended use. In other words, since the control signal did not relate to the usage of the information signal, the information signal is used according to the intended usage. Control then passes to step 210.

In step 260, usage control block 150 operates with other components of portable device 130 to limit the use of the information signal according to the control signal. Examples of the manner in which the usage can be limited, is described below with reference to various examples. Control then passes to step 210.

From the above, it may be appreciated that the use of information signals in portable device 130 can be limited by appropriate control signals received from a source other than from which the information signal is received. The control signals may be provided by usage specification device 160, and the description is accordingly continued with respect to the operation of an example embodiment of usage specification device 160.

4. Operation of Usage Specification Device

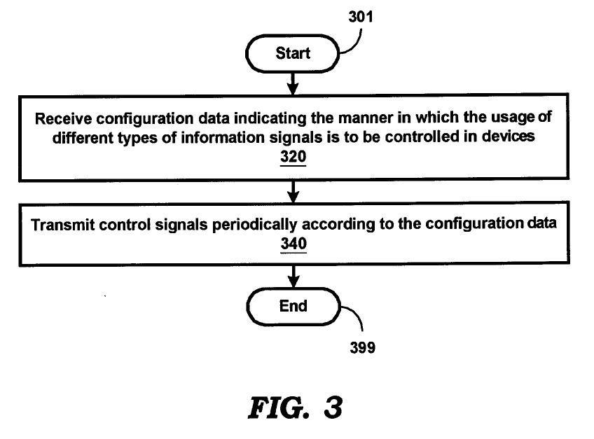

FIG. 3 is a flowchart illustrating the manner in which a usage specification device may operate to provide various aspects of the present invention. The flowchart is described with reference to FIG. 1 for illustration. However, the approaches can be used in other environments without departing from the scope and spirit of various aspects of the present invention, as will be apparent to one skilled in the relevant arts by reading the disclosure provided herein. The flowchart begins in step 301, in which control is transferred to step 320.

In step 320, usage specification device 160 receives configuration data indicating the manner in which the usage of different types of information signals is to be controlled (or limited) in various devices. The content of the configuration data depends on parameters such as differentiation needed (e.g., different users allowed to apply different controls, different controls applicable at different times of the day, etc.), control capabilities required, etc.

In step 340, usage specification device 160 transmits control signals (on wireless medium) periodically according to the configuration data. Due to the periodic transmission, a device may determine that no control is enforced for using an information signal if the corresponding control signal is not received for a certain time duration. The flowchart ends in step 399.

By transmitting the appropriate control signals, the use of the corresponding information signals can be limited in portable devices as described above. The approaches described above with respect to FIGS. 1, 2 and 3 can be used to provide various types of control as described below in further detail.

5. Zonal Control

Zonal control generally refers to limiting/controlling the use of an information signal in a desired area (zone). The manner in which zonal control can be attained according to various aspects of the present invention is described below in further detail.

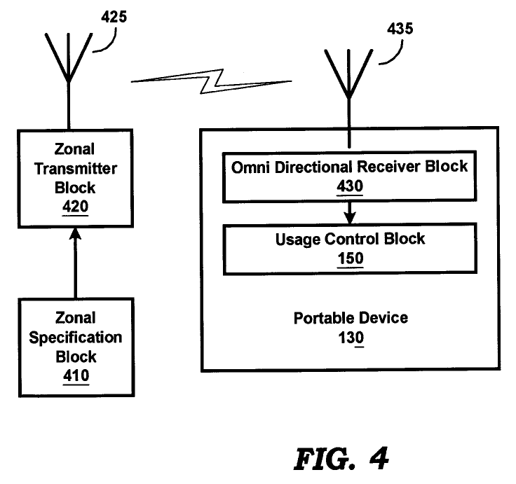

FIG. 4 is a block diagram illustrating the details of usage specification device 160 and portable device 130 to support zonal control in an embodiment of the present invention. Usage specification device 160 is shown containing zonal specification block 410, zonal transmitter block 420 and antenna 425. Portable device 130 is shown containing omni-directional receiver block 430 with omni-directional antenna 435 and usage control block 150. The blocks are described in further detail below.

Zonal specification block 410 determines the specific types of information signals to be controlled in the zone of interest at a present time, and interfaces with zonal transmitter block 420 to cause the corresponding control signals to be transmitted (using antenna 425). The determination may be based on various configuration data provided by a user (as described above with respect to step 320). The direction and strength of transmissions from zonal transmitter block 420 need to be controlled such that the desired zone/area is covered. Multiple zonal transmitters and/or zonal specification blocks can be used to achieve a desired zonal coverage.

Omni-directional receiver block 430 is designed to receive the control signals using omni-directional antenna 435 when in the zone, and provides the corresponding intimation to usage control block 150. In general, when the strength of a received signal exceeds a pre-specified threshold, the control signal may be deemed to be received. Omni-directional receiver block 430 can receive signals from any direction using omni-directional antenna 435 when in the zone. Thus, when a received control signal indicates that the use of the corresponding information signal is to be limited or prevented, usage control block 150 interfaces with other components in portable device 130 to limit the usage accordingly.

Accordingly, when it is desirable to disable the camera of mobile phones in a specific location (e.g. in an office where company-confidential images are displayed), zonal specification block 410 needs to be configured to cause corresponding control signals to be transmitted covering the extent of the premises. In response, mobile phones implemented according to the various aspects of the present invention would not permit image capture by mobile phone cameras in that office.

Similarly, audio/video/data capture can be also be controlled. In general, the above-described features can be applied to limit usage of any type of information signal in an entire area. The description is continued with respect to controlling the speaker/flash/light/RF transmission signal in an embodiment of the present invention.

6. Speaker/Flash/Light/RF Transmission Control

In an embodiment, the control signals received from zonal transmitter block 420 indicate locations where the output level of speaker needs to be reduced (potentially to zero). Thus, when usage control block 150 receives such control signals via omni-directional receiver block 430 (using omni-directional antenna 435), usage control block 150 interfaces with other components of portable device 130 to reduce the speaker level automatically (i.e. without user intervention).

Accordingly, with respect to mobile phones, the speaker level can be reduced to near zero while still permitting reception of calls in silent mode. As a result the solution permits all calls including emergency calls (since the signal carrying the voice communication is not jammed). Also, data messages (or even web browsing) can continue to be sent/received because the primary interest is in avoiding noise disturbance only.

While the description of above is provided with respect to speaker control for illustration, the features can be applied to other types of output signals as well. For example, another type of control signal may disable flash lights usage. In other words, when such a control signal is received, flash lights (used with cameras at the instant of taking a picture) would not turn on. Similarly, any lights present on a device (e.g. those of a display interface) may also be disabled or lowered in intensity in response to receiving a corresponding control signal, and RF transmission from the antenna of a device (e.g. which may interfere with flight systems on an aircraft or medical equipment in a hospital) may also be disabled in response to receiving a corresponding control signal.

While zonal control provides the ability to control usage of certain types of information signals in a large area, other types of control may be desired in such areas also. For example, with respect to capture of images, it may be desirable to prevent image capture of a person, either stationary or mobile. Another aspect of the present invention enables such control as described below in further detail.

7. Directional Control in Image Capture

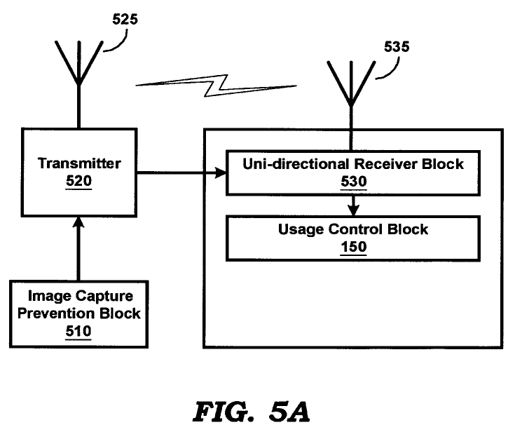

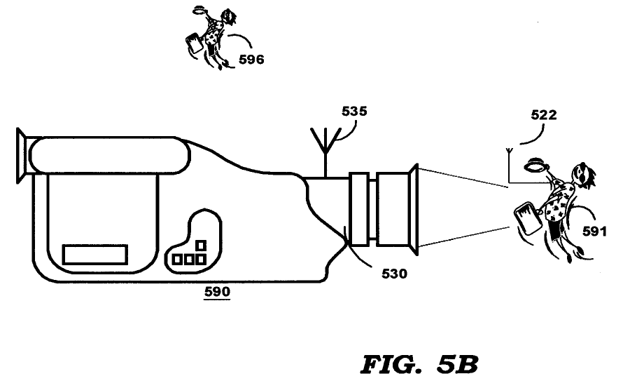

FIG. 5A is a block diagram containing the details of example embodiments of usage specification device 160 and portable device 130 to support directional control in image capture according to an aspect of the present invention. Usage specification device 160 is shown containing image capture prevention block 510 and transmitter 520 with antenna 525. Portable device 130 is shown containing uni-directional receiver block 530 (with uni-directional antenna 535) and usage control block 150. The blocks are described in further detail below.

Image capture prevention block 510 determines whether image capture of an object of interest is to be prevented at a present time, and interfaces with (omni-directional) transmitter 520 to cause the corresponding control signals to be transmitted using antenna 525 if such prevention is to be attained. Transmitter 520 is placed associated with (inside or next to) the object of interest and transmits control signals when so specified by image capture prevention block 510. The determination may be based on various configuration data provided by a user (as described above with respect to step 320).

Uni-directional receiver block 530 with uni-directional antenna 535 is designed to receive control signals only from a specific direction (or a narrow range/cone in that direction). Uni-directional antenna 535 is mounted to face the same direction as the lens (or equivalent image capturing components) which are designed to capture images. Thus, when uni-directional antenna 535 faces transmitter 520, control signals are successfully received (assuming that image capture prevention device 510 has caused the control signals to be transmitted in that interval). Uni-directional receiver block 530 forwards the received control signal to usage control block 150, which would prevent image capture in response.

FIG. 5B pictorially represents directional control in image capture. There is shown (video) camera 590, having mounted unidirectional receiver block 530 and uni-directional antenna 535. Camera 590 is shown facing object 591 which has transmitter 522 mounted. Due to the transmission of control signals (and reception thereof by uni-directional receiver block 530 using unidirectional antenna 535) from transmitter 522, camera 590 may not capture images of object 591 while it is within a specified range of object 591, i.e. while the received control signal from transmitter 522 exceeds a predefined level. On the other hand, no such transmitter is shown on object 596 in the same vicinity (and in a different direction). Camera 590 may accordingly capture images of object 596.

It should be appreciated that the operation of various features described above depends on whether portable device 130 contains a compliant implementation (i.e., whether usage control block 150 is implemented). An aspect of the present invention enables the determination of whether portable device 130 is implemented with a usage control block, as described below in further detail.

8. Determining Compliance

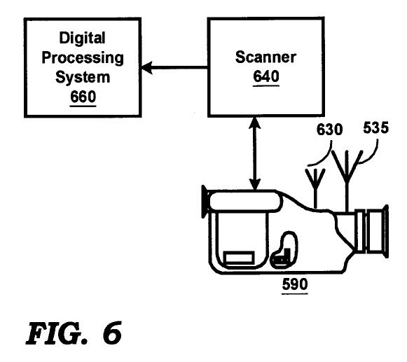

FIG. 6 is a block diagram illustrating the manner in which a determination can be made as to whether a portable device is compliant with various aspects of the present invention. There is shown camera 590 being scanned under scanner 640. Digital processing system 660 is shown in addition. Camera 590 is shown with additional antenna 630. The operation of each component/device is described below.

Camera 590 emits a digital code (via antenna 630) in response to a scan operation (or scan request received) from scanner 640, with the digital code indicating whether various control features are supported or not by camera 590. In one embodiment, the code contains multiple bits, with bits at pre-specified positions indicating whether corresponding uses can be limited. For example bit positions 30, 31, 32, 33, 34, 35, 36 and 37 can respectively indicate whether video/image capture in a zone can be limited, audio capture in a zone can be limited, data capture in a zone can be limited, directional image capture restrictions are supported, speaker volume can be muted, flash can be disabled, light display intensity can be minimized, RF transmission can be restricted, etc. (by having a bit value of 1 respectively). Thus, by confirming a bit value of 1 in the corresponding positions of the code, support for the desired control features can be confirmed.

The absence of reception of any code may further indicate that none of the control features is supported. When a digital code is received, scanner 640 transfers the code to digital processing system, which displays (or otherwise informs a user) the specific features (as being supported) indicated by the received code.

Scanner 640 and digital processing system 660 may be implemented in a known way. In one embodiment, scanner 640 is designed to test the presence of batteries (in a known way) in all the pieces carried by a person. If the presence of batteries is confirmed, each device containing batteries is checked for compliance as described in the previous paragraph. If a device is determined to support adequate controls (as described above), the device may be permitted into the premises.

Accordingly, only if a device causes undesirable disturbance or poses undesirable level of security risk (in terms of information capture), the device can be prevented from being carried into restricted area. For example, if noise is the disturbance of concern, only noise level can be controlled, while permitting features such as image/audio/data capture and flash/light/RF transmission output. Similarly, if audio/video capture only is of concern, only capture may be restricted, while permitting other uses. In other words, various aspects of the present invention would allow permissible uses of portable device, while restricting only the undesired uses.

Various embodiments of portable devices can be implemented supporting the features described above. The description is continued with respect to the details of an example embodiment of portable device.

9. Details of Portable Device

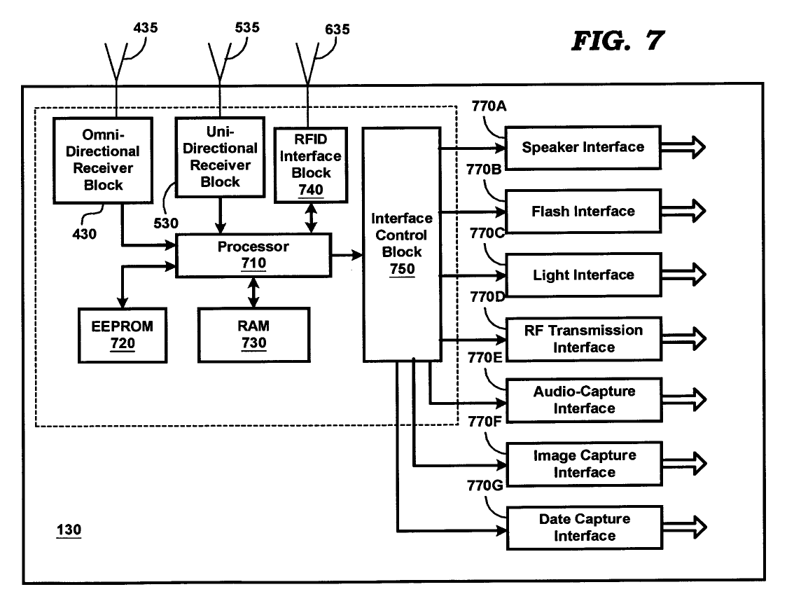

FIG. 7 is a block diagram illustrating the relevant details of portable device 130, supporting various features described above, in an embodiment of the present invention. Portable device 130 is shown containing omni-directional receiver block 430, unidirectional receiver block 530, antennas 435, 535 and 635, processor 710, EEPROM 720, RAM 730, RFID interface block 740, interface control block 750, speaker interface 770A, flash interface 770B, light interface 770C, RF transmission interface 770D, audio capture interface 770E, image capture interface 770F, and data capture Interface 770G. Blocks 430, 530, 710, 720, 730, 740 and 750 may be integrated into a single system on a chip (SOC), as represented by a dotted line around the components. Each block is described below in further detail.

First it is noted that various details not relevant to an understanding of the features of the present invention are not included in FIG. 7 to avoid obscuring the more pertinent details. For example, the specific blocks which perform audio/video capture (interfacing with 770E-770F), etc., are not included. Similarly, RF transmission interface 770D may be connected with an appropriate antenna (either 435 or another antenna, not shown). Also, usage control block 150 may be viewed as containing (or implemented using) processor 710, interface control block 750, EEPROM 720 and RAM 730. Also, the description of blocks (430, 435, 530, 535) introduced in previous diagrams is not repeated in the interest of conciseness.

Speaker interface 770A, flash interface 770B, light interface 770C and RF transmission interface 770D, audio capture interface 770E, image capture interface 770F and data capture Interface 770G respectively operate to provide control of speaker output, flash output, light output, RF transmission signal output, audio capture, image capture and data capture by interfacing with corresponding blocks (not shown) under the control of interface control block 750. In general, each interface needs to be implemented consistent with the requirements of the corresponding block, and several such implementations will be apparent to one skilled in the relevant arts.

In particular, RF transmission interface 770D may be controlled to disable non-emergency voice conversations (voice calls) only (if so desired, consistent with a corresponding control signal). To support such a feature, processor 710 may need to monitor the signaling related data which sets up a call between end points of a voice conversation. The emergency voice conversations can be determined based on data such as various control flags (e.g., a flag may specify that the call is for emergency purposes), the telephone number at the other end (e.g., 911 in case of United States of America), etc. In general, the detection of emergency calls generally depends on the specific protocol being used for signaling (or call setup), and implementation of such detection will be apparent to one skilled in the relevant arts by reading the disclosure provided herein. Once it is determined to disable voice conversations, processor 710 may provide the appropriate interface signals to interface control block 750 to disable undesired voice conversations.

Similarly, interface control block 750 may provide appropriate signals to speaker interface 770A (which causes audible signals to be produced on an appropriate speaker device) to mute (or reduce volume) of audio/speaker signals generated. Another type of signals may be provided to audio capture interface 770E to restrict (prohibit) capture as specified by interface control block 750. Interface control block 750 may provide other types of signals to image capture interface 770F to restrict image capture, to data capture interface 770G to restrict data capture, to flash interface 770B to disable flash, to light interface 770C to lower the intensity of the display or to disable the display entirely, and to RF transmission interface 770D to disable RF transmissions.

RFID interface block 740 consists of a RFID tag with a read-only 2 kB data store (available with standard RFID tags in the market). The contents of the data store can be read when it is scanned by an external RFID scanner (e.g. scanner 640). The scanable data in the RFID block corresponds to the bit-wise information on various device control capabilities, as well as various device identification data. The implementation of the RFID interface block 740 will be apparent to one skilled in the relevant arts by reading the disclosure provided herein.

EEPROM 720 contains various instructions, which can be executed by processor 710 to provide various features of the present invention. The instructions can be either executed directly from EEPROM 720, or loaded into RAM 730 prior to execution. Various commercially available components can be used to implement EEPROM 720 and processor 710.

Processor 710 receives various control signals from blocks 430 and 530, and performs corresponding actions to provide various features of the present invention. The actions are performed by providing appropriate data/signals to interface control block 750. Thus, for example, if a control signal received via omni directional antenna 435 indicates that audio capture is to be prohibited (in the zone of operation), processor 710 may interface with interface control block 750 and audio capture interface block 770E to disable audio capture

Similarly, if a control signal received via uni-directional antenna 535 indicates that image capture is prohibited, processor 710 may interface with interface control block 750 to disable image capture using image capture interface 770F. As another example, if RFID interface block 740 indicates that a scan request is received (from scanner 640), the corresponding code may be embedded as a part of the 2 kB data store on RFID interface block 740, which can transmit the code in response to the scan operation. In yet another alternative embodiment, the code (representing the control functions supported by the device) may be hard-coded (embedded) into RFID interface block 740, and such hard-coded code may be transmitted in response to a scan request.

Thus, the use of information signals by multiple devices is limited by sending control signals from potentially a single source (i.e., usage specification device 160). Also, in such situations, the source of the information signals (e.g. a voice/sound sought to be protected from audio capture, a USB port /WLAN network /miscellaneous data feed sought to be protected from data capture) is physically separate from usage specification device 160. The description is continued with respect to additional implementation details.

10. More Implementation Details

It should be appreciated that the features of above are designed for situations in which devices can be spread in a large area (e.g., in a huge office building, theaters, etc,.). Accordingly, usage specification device 160 needs to be designed to transmit signals over a long distance (exceeding 15 feet). Radio frequency (RF) signals are suitable for encoding the control signals and for corresponding transmissions.

In one embodiment, a single usage specification device is designed to transmit different types of control signals intended for different types of controls (some of which are described above). A different frequency band is used for different types of control signals in such an embodiment, such that mere reception of that frequency band signifies the control signal. Alternatively, more complex encoding approaches which contain packet formats for more flexible control can be employed without departing from the scope and spirit of various aspects of the present invention, as will be apparent to one skilled in the relevant arts by reading the disclosure provided herein.

The features described above can be implemented in several embodiments. The description is continued with respect to an embodiment in which various features are operative by execution of appropriate software instructions as described below.

11. Digital Processing System

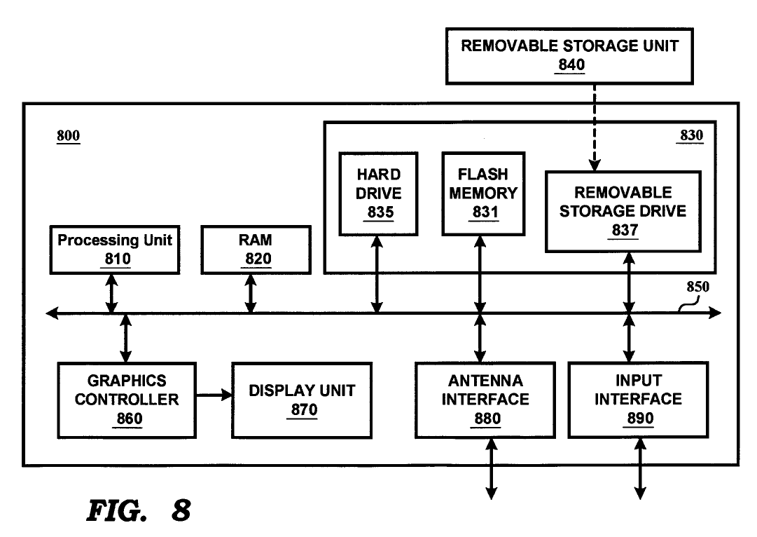

FIG. 8 is a block diagram of computer system 800 illustrating an example system in which various aspects of the present invention can be implemented. Computer system 800 may correspond to portable device or usage specification device, described above. System 800 may contain one or more processors such as central processing unit (CPU) 810, random access memory (RAM) 820, secondary memory 830, graphics controller 860, display unit 870, antenna interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present invention (by performing tasks corresponding to various approaches described above). CPU 810 may contain multiple processing units, with each processing unit potentially being designed for a specific task. Alternatively, CPU 810 may contain only a single processing unit. RAM 820 may receive instructions from secondary memory 830 using communication path 850.

Graphics controller 860 generates display signals (e.g., in RGB format) to display unit 870 based on data/instructions received from CPU 810. Display unit 870 contains a display screen to display the images defined by the display signals. Input interface 890 may correspond to a key-board and/or mouse, and generally enables a user to provide inputs. Antenna interface 880 enables system 800 to receive/transmit various signals using an external antenna.

Secondary memory 830 may contain hard drive 831, flash memory 836 and removable storage drive 837. Secondary storage 830 may store the software instructions (which perform the actions specified by various flow charts above) and data, which enable computer system 800 to provide several features in accordance with the present invention. Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable storage medium having stored therein computer software and/or data. An embodiment of the present invention is implemented using software running (that is, executing) in computer system 800.

In this document, the term “computer program product” is used to generally refer to removable storage unit 840 or hard disk installed in hard drive 831. These computer program products are means for providing software to computer system 800. As noted above, CPU 810 may retrieve the software instructions, and execute the instructions to provide various features of the present invention.

### 12. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A system covering a large area, said system comprising:
a plurality of devices located in said large area, each device being designed to use an information signal according to the intended use of said information signal; and
a usage specification device sending a control signal which is designed to limit use of said information signal by said plurality of devices, wherein said control signal is sent on a wireless medium,
said plurality of devices receiving said control signal, decoding the information in said information signal, and limiting use of said information signal according to said control signal,
wherein the source of said information signal is physically separate from said usage specification device.

2. The system of claim 1, wherein at least some of said plurality of devices are located at a distance exceeding 15 feet from said usage specification device.

3. The system of claim 2, wherein said control signal is sent in the form of a radio frequency (RF) signal.

4. The system of claim 2, wherein each of said plurality of devices does not limit usage of other types of information signals in response to receiving said control signal.

5. The system of claim 4, wherein a first device comprises the ability to support voice conversations using mobile phone technology, wherein said information signal encodes a voice conversation, said control signal disables support for voice conversations other than emergency calls in response to receiving said control signal, wherein said first device is comprised in said plurality of devices.

6. The system of claim 2, wherein said control signal is designed to limit the use of said information signal in a zone, wherein each of said plurality of devices is determined to be in said zone if a strength with which said control signal is received from said usage specification device exceeds a pre-specified threshold.

7. The system of claim 6, wherein the use of said information signal comprises reproducing the information contained in said information signal.

8. The system of claim 7, wherein said information comprises audible signal, and said control signal causes said first device to change the audio level.

9. The system of claim 6, wherein a second device comprises a capture device, said information signal comprises information to be captured, wherein said second device is designed to disable capturing of said information in response to receiving said control signal, said second device being contained in said plurality of devices.

10. The system of claim 9, wherein said information comprises an image such that image capture is limited due to said control signal.

11. The system of claim 9, wherein said information comprises an audio signal such that audio capture is limited due to said control signal.

12. The system of claim 9, wherein said information comprises data such that data capture is prohibited due to said control signal.

13. The system of claim 6, wherein the said control signal is designed to limit the strength of an output signal generated by each of said plurality of devices, wherein the devices in said zone receive said control signals and limit the strength of said output signal according to said control signal.

14. The system of claim 13, wherein said output signal comprises speaker output and said strength comprises speaker volume.

15. The system of claim 13, wherein said output signal comprises a flash output and said strength comprises an intensity of corresponding light.

16. The system of claim 13, wherein said output signal comprises a light output and said strength comprises an intensity of corresponding light.

17. The system of claim 2, wherein each of said plurality of devices comprises a directional antenna which receives signals only in a direction, wherein each of said plurality of devices limits use of said information signal if said control signal is received by said directional antenna.

18. The system of claim 17, wherein said information signal comprises an image such that capture of said image is prevented if said image is being received in said direction.

19. The system of claim 18, wherein said usage specification device is placed associated with a source of said image such that said source is not captured in the form of an image.

20. A device comprising:
a first interface block designed to control the manner in which a corresponding information signal is used; and
a second interface block providing a code indicating whether said first interface block can be caused to limit use of said information signal in response to receiving a control signal.

21. The device of claim 20, wherein said second interface block transmits said code in response to receiving a scan request.

22. The device of claim 21, further comprising a processor generating said code, said code further indicating the specific ones of a plurality of uses of a plurality of information signals, which can be controlled.

23. The device of claim 21, further comprising a plurality of interface blocks including said first interface block, wherein said plurality of interface blocks control the use of corresponding ones of said plurality of information signals, said processor being designed to interface with said plurality of interface blocks to control corresponding use in response to receiving corresponding control signals.

24. The device of claim 23, wherein said plurality of information signals comprise data signal, an audio signal, and an image signal, and said corresponding use comprises capturing data, audio and image respectively.

25. The device of claim 21, further comprising an output interface generating an output signal, wherein said code indicates whether the specific uses of said output signal which can be controlled by receiving appropriate control signals from an external source.

26. The device of claim 21, wherein said output signal comprises one of speaker output, a flash output, and a light output.

27. The device of claim 21, wherein said specific uses comprise capture of said information and reproducing said information

28. A method of determining whether to permit a device in an area, said method comprising:
subjecting said device to a scan operation;
determining whether a code is received in response to said scan operation;
examining said code to check whether said device would limit use of one or more information signals of interest upon receiving corresponding control signals; and
permitting said device in said area only if said code is received and said code indicates that said device would limit use of one or more information signals of interest upon receiving corresponding control signals.
